(19) United States
(12) Patent Application Publication
(10) Pub. No.: US 2025/0149812 A1
(43) Pub. Date: May 8, 2025

(54) CARD EDGE CONNECTOR WITH AN IMPROVED LOCKING AND RELEASING MECHANISM

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: KUO-CHUN HSU, New Taipei (TW); MING-YI GONG, Huaian (CN); YU-CHE HUANG, New Taipei (TW); XUN WU, Huaian (CN); PO-FU CHEN, New Taipei (TW); WEN-LUNG HSU, New Taipei (TW)

(21) Appl. No.: 18/926,992

(22) Filed: Oct. 25, 2024

(30) Foreign Application Priority Data
Nov. 3, 2023 (CN) 202322972058.X

(51) Int. Cl. H01R 12/72; H01R 12/70; H01R 12/73

(52) U.S. Cl. CPC H01R 12/721; H01R 12/7005; H01R 12/737

(57) ABSTRACT

A card edge connector includes: a housing having a mating slot for insertion of an electronic card; plural terminals retained in the housing; a latch mounted at a first longitudinal end of the housing; a movable key received in the housing; and a rod attached to the housing, wherein the latch and the movable key are connected with opposite ends of the rod, and the movable key is pushable downwards to push the rod to move in a longitudinal direction to bring the latch to a locked state.

### BACKGROUND OF THE INVENTION

### Field of the Invention

The present invention relates generally to a card edge connector, and particularly to a card edge electrical connector with an improved locking and releasing mechanism.

### Description of Related Arts

Mother boards on computers, servers and other devices have multiple electrical connectors for expanding functions, such as AGP connector, PCI connector and USB connector. Electronic cards, such as display card or network card, are inserted into various connectors on the mother board and locked by latches of the connectors to expand the function of the computer. It may be difficult for users to release the latch by hand or through a tool. China Patent No. 102082339B discloses a connecting member extending from the latch, and the user pulls the connecting member to release the locking relationship between the latch and the card. U.S. Pat. No. 11,868,187 discloses a transmission mechanism added beside the connector. The user presses the transmission mechanism to transmit the force to rotate the latch outwards and release the locking engagement of the latch. It requires a user to exert force on the card while acting on the connecting member or the transmission mechanism, i.e., releasing the latch firstly and then pulling out the electronic card.

An improved card edge connector is desired.

### SUMMARY OF THE INVENTION

An object of the present invention is to provide a card edge connector with an automatic locking and ejecting mechanism.

To achieve the above-mentioned object, a card edge connector comprises: a housing having a first longitudinal end, two opposite side walls, and a mating slot located between the two side walls and extending in a longitudinal direction for insertion of an electronic card; a plurality of terminals retained in the housing; a latch mounted at the first longitudinal end of the housing; a key movably being received in the housing and pushable by the electronic card to move downwards, the key having two guiding lumps; and two rods attached at the side walls and each being made from a metal plate and having a first end and a second end opposite the first end, wherein the first ends of the two rods are retained with the latch, the second ends of the two rods each have an inclined guiding slot, the guiding lumps of the key are received by and slides in the guiding slots, the guiding slot has an upper end and a lower end, and the rod comprises a longitudinal spring portion providing a restoring force after the guiding lamp is moved to the lower end of the guiding slot.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of a card edge connector mounted on a circuit board and an electronic card separated from the card edge connector, according to an embodiment of the present invention;

FIG. 2 is an exploded perspective view of the card edge connector on the circuit board of FIG. 1;

FIG. 3 is a perspective view of the card edge connector inserted with the card of FIG. 2;

FIG. 4 is another exploded perspective view of the card edge connector of FIG. 2;

FIG. 5 is a further exploded perspective view of the card edge connector in FIG. 2;

FIG. 6 is a further exploded perspective view of the card edge connector in FIG. 4; and

FIG. 7 is a cross-sectional view taken along line A-A in FIG. 3.

### DETAILED DESCRIPTION OF THE PREFERRED EMBODIMENT

Reference will now be made to the drawing figures to describe the preferred embodiment of the present invention in detail.

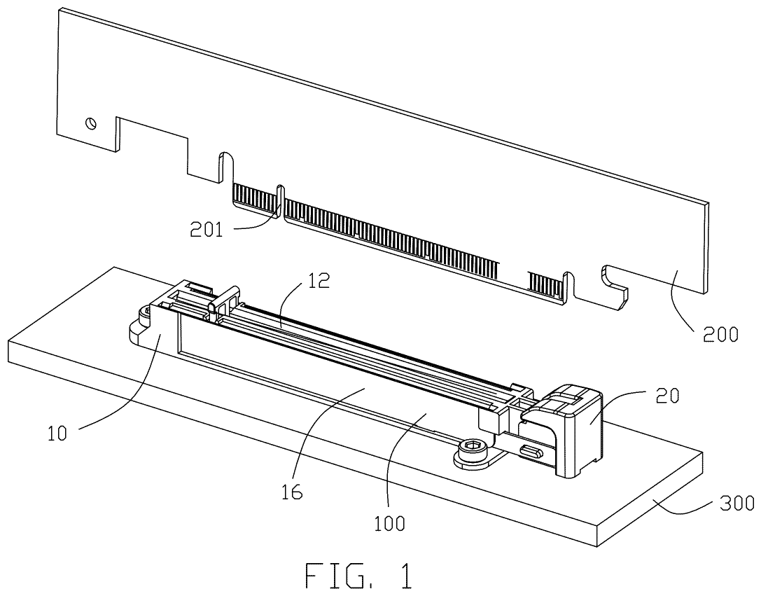

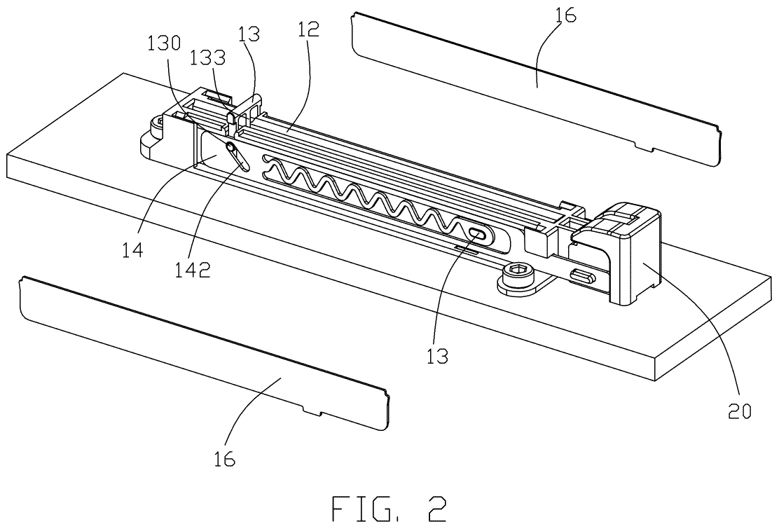

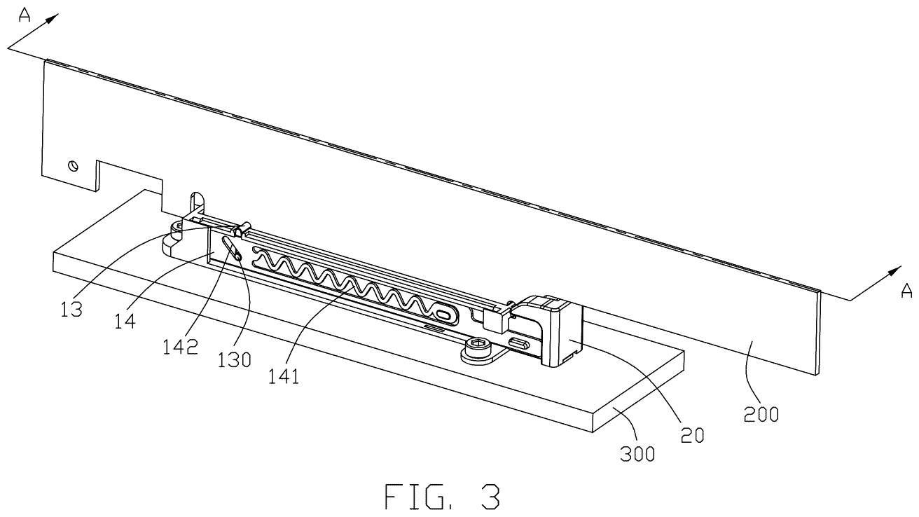

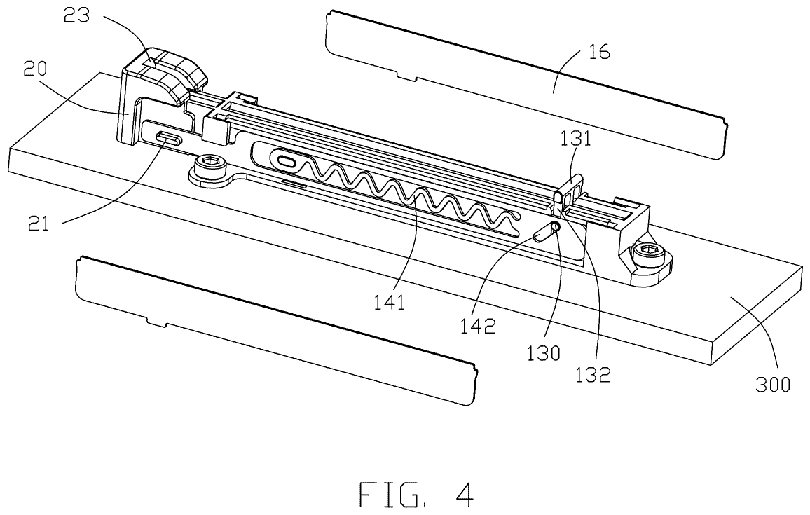

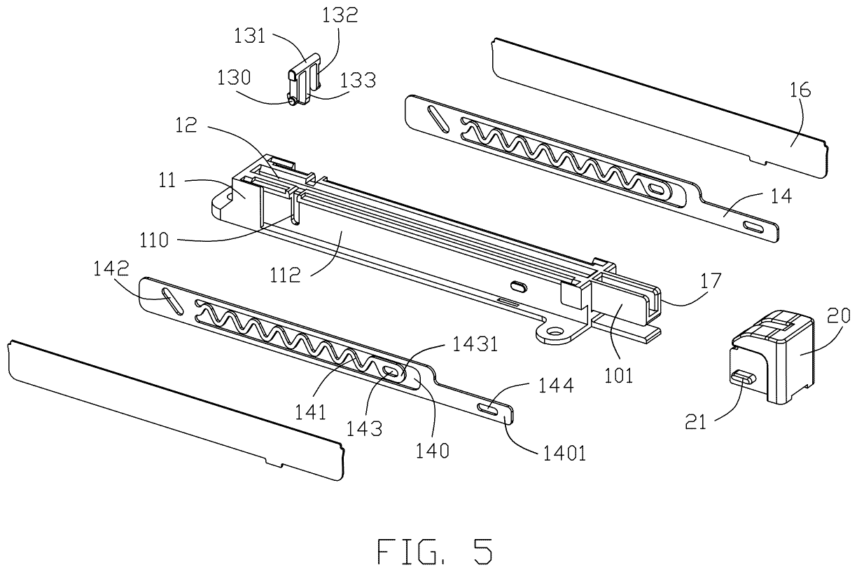

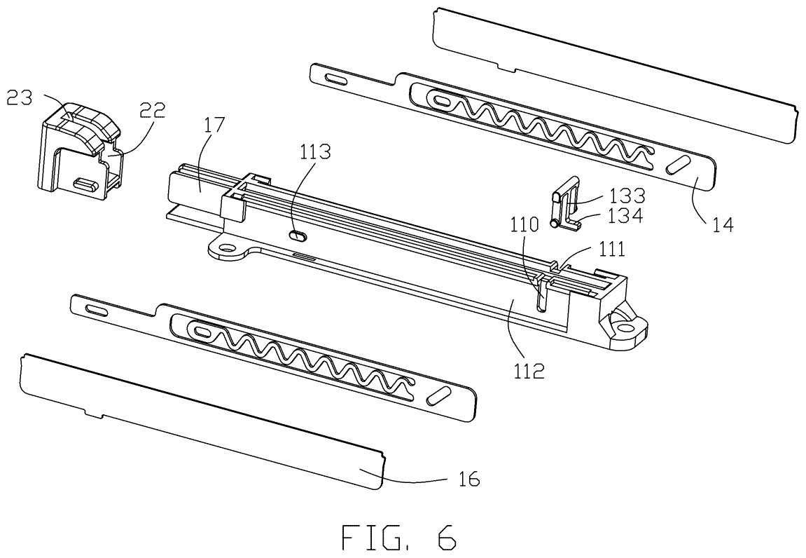

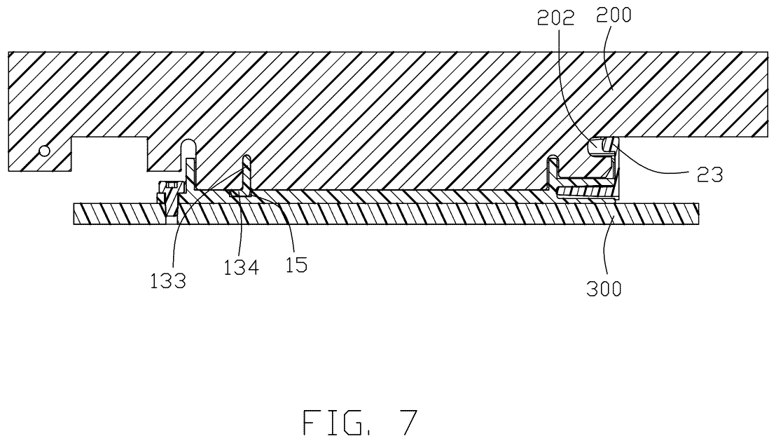

Referring to FIGS. 1-3, a card edge connector 100 of the present invention is mounted on a circuit board 300 and adapted for insertion with an electronic card 200 so as to establish an electrical connection between the circuit board and the card. Combined with FIGS. 5-6, the card edge connector 100 comprises an elongate insulating housing 10 extending along a longitudinal direction, a plurality of terminals retained in the housing, and a latch 20 mounted to a first longitudinal end 101 of the housing 10. The housing 10 comprises two opposite side walls 11 extending along the longitudinal direction and a mating slot 12 is defined between the two side walls 11. The mating slot 12 is used to be inserted with the electronic card 200. The terminals are fixed to the housing 10 and have contacting portions extending into the mating slot 12 for electrically contacting with the electronic card 200. The card edge connector 100 further comprises a moveable key 13 and two rods 14 arranged on the side walls 11. The key 13 slides in an upright direction in the side walls 11 between an upper position and a lower position. Two opposite longitudinal ends of each rod 14 are connected with the key 13 and the latch 20 respectively, and the rods are pushed to move in the longitudinal direction by the key 13. Referring to FIG. 4 and FIG. 7, the latch 20 comprises a locking portion 23 aligned with the mating slot 11. The locking portion 23 is buckled in a notch 202 of the electronic card 200 to lock the electronic card 200 in the connector. During the electronic card 200 is inserted into the mating slot 11, the electronic card 11 pushes the key 13 to move downwards and then the downward movement of the key 13 pull the rod 14 to move in the longitudinal direction, the moving rod 14 brings the latch 20 from an open state as shown in FIG. 2 to a locked state shown in FIG. 3 and FIG. 7 wherein the electronic card 200 is locked in the connector. That means, the electronic card 200 is locked during the insertion of the card, enabling one-handed operation, which is beneficial to simplifying the operation steps.

Referring to FIGS. 2-3 and FIG. 5, the rod 14 has a longitudinal opening 140 extending in the longitudinal direction between two opposite longitudinal ends of thereof, and a longitudinal spring portion 141 arranged in the longitudinal opening 140. A first end 1431 of the spring portion 141 near the latch 20 is retained to the side wall 11 by a first fixing hole 143 being retained in a first fixing hole 143, a second end opposite to the first end of the spring portion 141 is unitarily connected with an inner edge of the longitudinal opening 140 near a second longitudinal end opposite to the first longitudinal end 101 of the housing. A first longitudinal end 1401 of the rod 14 is retained with the latch 20 by a second fixing hole 144 being retained with a second fixing block 21. Therefore, the latch 20 moves companied with the movement of the rod 14. In this embodiment, the rods 14 moves in the longitudinal direction, the latch 20 also move in the longitudinal direction. The latch alternately rotates from the opening state to the locked state in other embodiment. The rod 14 has an inclined guiding slot 142 at the second longitudinal end thereof, a lower end of the guiding slot 142 is closer to the latch 20 than an upper end of the guiding slot 142 in the longitudinal direction. The key 13 has a guiding lamp 130 protruding into the guiding slot 142. The guiding lamp 130 can slide in the guiding slot 142. After the key 13 move downwards, the guiding lamp 130 is located at a lower-right position of the guiding slot 142 as shown in FIG. 2.

In the open statute as shown in FIG. 2, the key 3 is located at an upper position wherein the key 13 protrudes upwards beyond the top face of the insulating housing, the key 13 is kept in this upper position by the spring portion 141 in a free state or a slightly compressed state. The guiding lamps 130 are located at an upper end of the guiding slot. That means, the spring portion 141 in an original state will keep the key 13 in the upper position. The latch 20 is in a far position in condition that the lath is ready for the insertion of the card. During the insertion of the card, the key 13 moves downwards in the upright direction, the guiding lamps 130 move to the lower ends of the guiding slots 142, resulting that the rods 14 move away from first longitudinal end 101 or towards the second longitudinal direction. The movement of the rods 14 away from the first longitudinal end is companied with a horizontal movement of the latch 20 away from the first longitudinal end in the long direction, i.e, the latch 20 moves from the far position to a near position wherein the latch 20 is in the locked state. At this time, the spring portions 141 are lengthened and stretched in the longitudinal direction. The stretched spring portions 141 have a restoring force to return the rod 14 toward the first longitudinal direction, that is the opening state.

After the locking portion 23 is released from the notch 202, the stretched spring portions 141 restore and move towards the first longitudinal end. Due to the guiding lumps 130 are located at a same position in the longitudinal direction, the whole rods 14 at an aim of the guiding slots 142 move towards the first longitudinal end 101, which brings the latch 20 moves to the far position so that the latch 20 is in the opening state. At the same time, the inclined guiding slot 142 push the key 13 to move upward so as to push the card out of the mating slot 12.

Referring to FIGS. 5-6, the rods 14 have the inclined guiding slots 142 at the second end thereof, a lower end of the guiding slot 142 is closer to the latch 20 than an upper end in the longitudinal direction. The guiding lamps 130 slide in the guiding slots 142 so that the rods 14 drive the latch 20 to move relative to the housing 10 in the longitudinal direction. In other embodiments, the first end 1431 is unitarily connected with the inner edge of the longitudinal opening 140, the second end is retained with the side wall, the spring portion in the opening state is in a free state or a slight stretched statute. After the key move downwards, the rods still moves away from the first longitudinal end 101, since the second ends of the spring portions are retained, so the spring portions are compressed and have a restoring force. After the latch is released, the compressed spring portions move towards the first longitudinal end since the second end of the spring portions are retained and unmovable, which push the rods towards the first longitudinal end

Referring to FIG. 2 and FIGS. 4-5, the key 13 comprises a bridge portion 131 spanning across the two side walls 11 and arm portions 132 extending downward from the bridge portion 131. The guiding lamp 130 protrudes outward from the arm portion 132 to the side wall 11. The bridge portion 131 is accommodated in a first notch 201 of the electronic card 200. The electronic card 200 pushes the bridge portion 131 downward to cause the guiding lamp 130 sliding along the guiding slot 142 until the bridge portion 131 lies on the two side walls 11. As shown in FIGS. 5-6, in this embodiment, the outer surface of the side wall 11 has a vertical groove 110 for accommodating the arm portion 132. Two top surfaces of the two side walls 11 have a horizontal groove 111 for accommodating the bridge portion 131. In this way, after the electronic card 200 is inserted into the card edge connector 100, the overall size of the card edge connector 100 will not be enlarged due to the key 13 is in the side wall. The key 13 comprises a supporting portion 133 extending from the bridge portion 131 into the mating slot 12. The supporting portion 133 extends downward beyond the arm portions 132. Referring to FIG. 7, a recessed groove 15 is located below the mating slot 12. An abutting portion 134 extending longitudinally is disposed at a lower end of the supporting portion 133. After the key 13 is pushed downward, the abutting portion 134 is received in the recessed groove 15 and abuts against the insulating housing 10, which can prevent the key 13 from being over-pressed.

Referring to FIG. 2 and FIGS. 4-6, the card edge connector 100 comprises two metal plates covering the rod 14. An outer surface of the side wall 11 has a receiving groove 112 recessed inwardly. The rod 14 and the baffle 16 are both arranged in the receiving recess 112. The vertical groove 110 is substantially formed by further inward depression from the receiving recess 112. The rod 14 is made of a metal plate and is attached to the side wall 11 in the receiving recess 112. The spring portion 141 is wavy, which is conducive to reduce the volume of the card edge connector 100. The side wall 11 has the first fixing block 113 protruding outward. An extending end of the spring portion 141 has the first fixing hole 143. The first fixing block 113 is retained in the first fixing hole 143. The latch 20 comprises the second fixing block 21 protruding laterally. The rod 14 comprises the second fixing hole 144 which is retained in the second fixing block 21.

Referring to FIGS. 5-6, the housing 10 has a slide rail 17 arranged at the first longitudinal end 101 thereof. The latch 20 has a cavity 22 opening toward the housing 10. Referring to FIGS. 1 and 3, the slide rail 17 extends to the cavity 22 so that the latch 20 moves along the slide rail 17. As shown in FIG. 7, the locking portion 23 of the latch extends to the cavity 22. In this embodiment, the rods 14 for controlling the latch 20 are symmetrically arranged on the two side walls 11, which is conductive to force balance of the plugged card 200.

The above-mentioned embodiments are only preferred embodiments of the present invention, and should not limit the scope of the present invention, any simple equivalent changes and modifications made according to the claims of the present invention and the contents of the description should still belong to the present invention.

1. A card edge connector comprising:
a housing having a first longitudinal end, two opposite side walls, and a mating slot located between the two side walls and extending in a longitudinal direction for insertion of an electronic card;
a plurality of terminals retained in the housing;
a latch mounted at the first longitudinal end of the housing;
a key movably being received in the housing and pushable by the electronic card to move downwards, the key having two guiding lumps; and
two rods attached at the side walls and each being made from a metal plate and having a first end and a second end opposite the first end;
wherein the first ends of the two rods are retained with the latch, the second ends of the two rods each have an inclined guiding slot, the guiding lumps of the key are received by and slides in the guiding slots, the guiding slot has an upper end and a lower end, and the rod comprises a longitudinal spring portion providing a restoring force after the guiding lamp is moved to the lower end of the guiding slot.

2. The card edge connector as claimed in claim 1, wherein during inserting the electronic card into the mating slot, the key is pushed by the electronic card to move downwards and the guiding lumps slide downward in the inclined guiding slots to move the rods away from the first longitudinal end of the housing and bring the latch to a locked state to lock the electronic card and to stretch or compress the spring portions.

3. The card edge connector as claimed in claim 1, wherein each of the rods has a longitudinal opening and the spring portion extends in the longitudinal opening.

4. The card edge connector as claimed in claim 1, wherein a first end of the spring portion near the first longitudinal end is retained to the side wall, a second end of the spring portion unitarily extending from an inner edge of the longitudinal opening.

5. The card edge connector as claimed in claim 1, wherein the key comprises a bridge portion spanning across the two side walls and a pair of arm portions extending downward from the bridge portion, the guiding lumps protrude outwards from the arm portions to the side walls, and the bridge portion is pushable downward by the electronic card to cause the guiding lumps sliding in the guiding slot until the bridge portion lies on the side walls.

6. The card edge connector as claimed in claim 5, wherein the key comprises a supporting portion extending from the bridge portion into the mating slot, and a recessed groove is located below the mating slot, and after the key is pushed downward a lower end of the supporting portion is received in the recessed groove and abuts against the housing.

7. The card edge connector as claimed in claim 1, further comprising two metal plates, wherein an outer surface of the side wall has a receiving recess, and the rods are arranged in the receiving recesses and the metal plates cover the rods.

8. The card edge connector as claimed in claim 1, wherein the rod is made from a metal plate and is attached at the side wall, and the spring portion is wavy.

9. The card edge connector as claimed in claim 7, wherein the side wall has a first fixing block protruding outward, the spring portion has a first fixing hole at the second end thereof, and the first fixing block is retained in the first fixing hole.

10. The card edge connector as claimed in claim 3, wherein the latch comprises two second fixing blocks protruding laterally, and the rods comprise second fixing holes retained with the second fixing blocks.

11. The card edge connector as claimed in claim 9, wherein the housing has a slide rail arranged at the first longitudinal end thereof, and the latch moves along the slide rail.

12. A card edge connector comprising:
a housing having a mating slot for insertion of an electronic card;
a plurality of terminals retained in the housing;
a latch mounted at a first longitudinal end of the housing;
a movable key received in the housing; and
a rod attached to the housing;
wherein the latch and the movable key are connected with opposite ends of the rod, and the movable key is pushable downwards to push the rod to move in a longitudinal direction to bring the latch to a locked state.

13. The card edge connector as claimed in claim 12, wherein a spring portion is disposed on the rod, the key is movable between an upper position and a lower position, and the spring portions keep the key in the upper position or restores the key from the lower position to the upper position.

14. The card edge connector as claimed in claim 13, wherein the rod has a longitudinal opening extending in the longitudinal direction and the spring portion extends from the rod toward the first longitudinal end in the longitudinal opening, and a free end of the spring portion is retained with the side wall.

15. The card edge connector as claimed in claim 12, wherein the rod has an inclined guiding slot, the key has a guiding lump slidable in the guiding slot, the guiding slot has an upper end and a lower end, the lower end is closer to the first longitudinal end than the upper end.

16. The card edge connector as claimed in claim 14, wherein the rod is made from a metal plate and is attached to the side wall, and the spring portion is wavy.

17. A card edge connector comprising:
a housing having a first longitudinal end and a mating slot between two opposite side walls thereof to receive an electronic card;
a plurality of terminals disposed in the housing;
a latch assembled at the first longitudinal end of the housing;
a key being pushable to move from an upper position to a lower position;
a rod attached at the side walls with a first end and a second end opposite to the first end; and
a spring portion;
wherein the first end of the rod is retained with the latch, the second end of the rod is slidably connected with the key, the key is kept in the upper position by the spring portion and is pushable by an inserted electronic card to the lower position.

18. The card edge connector as claimed in claim 17, wherein the rod has an inclined guiding slot, and the key has a guiding lump sliding in the guiding slot.

19. The card edge connector as claimed in claim 17, wherein the rod is made from a metal plate, and the spring portion is unitarily formed on the rod.
